(19) United States
(12) Patent Application Publication
(10) Pub. No.: US 2019/0308283 A1
(43) Pub. Date: Oct. 10, 2019

(54) WELDED TITANIUM STRUCTURE UTILIZING DISSIMILAR TITANIUM ALLOY FILLER METAL FOR ENHANCED FATIGUE LIFE

(71) Applicant: The Boeing Company, Chicago, IL (US)

(72) Inventors: Catherine J. Parrish, Sao Paulo (BR); Robert D. Briggs, Auburn, WA (US); Gary W. Coleman, Snohomish, WA (US); Frederick W. Buldhaupt, South Prairie, WA (US)

(21) Appl. No.: 15/945,337

(22) Filed: Apr. 4, 2018

(51) Int. Cl. B23K 35/32; C22C 14/00

(52) U.S. Cl. CPC B23K 35/325; C22C 14/00

(57) ABSTRACT

Provided is a method for welding dissimilar types of titanium. The method utilizes a filler metal that is also dissimilar to the types of titanium being welded. The method forms welds with improved fatigue life at room and high temperatures with no loss of tensile strength compared to welds formed by conventional methods of welding titanium.

### FIELD

The present disclosure generally relates to welding titanium and, in particular, to welding dissimilar alloys of titanium.

### BACKGROUND

Many industries including aerospace, automotive, medical, and sporting goods utilize titanium and titanium alloys. These and other industries often weld dissimilar types of titanium alloys together during manufacturing. Titanium alloys can be classified into three types, alpha, beta, and alpha-beta, based on their chemical content and crystal structure. Alpha type titanium alloys have predominantly a hexagonal close packed crystal structure. They generally exhibit high corrosion resistance, low to medium strength, good mechanical properties at cryogenic and elevated temperatures, and minimal heat treatability. They can include alloying elements such as aluminum, oxygen, nitrogen or carbon as alpha phase stabilizers. Examples of alpha type titanium alloys include Ti—6Al—2Sn—4Zr—2Mo (Ti 6242) and Ti—8Al—1Mo-1V. Beta type titanium alloys have a predominantly body centered cubic crystal structure and generally possess high strength, high formability, and heat treatability. These alloys can include elements such as vanadium, molybdenum, iron, niobium, and chromium as beta phase stabilizers. Examples of beta type titanium alloys include Ti—10V2Fe3Al and Ti—15Mo—3Al—2.7Nb—0.25Si (Beta 21S). Alpha-beta type titanium alloys contain a mixture of both alpha and beta type titanium. One of the most commonly used alpha-beta type titanium alloys is Ti—6Al—4V.

When welding dissimilar types of titanium, selection of a filler metal has been limited to alloys of a similar type to one of the alloys being joined. The American Welding Society (AWS) Welding Handbook Volume Five, Ninth Edition, instructs that the filler metal should match one of the types of titanium being joined in Chapter 6, pages 407-408. For example, an alpha type titanium filler metal or a beta type titanium filler metal should be used to join an alpha type titanium workpiece to a beta type titanium workpiece. This insures that the weld joint be as strong as the type of titanium with the weaker tensile strength.

### SUMMARY

According to the present teachings, a method for welding dissimilar types of titanium is provided. The method includes providing a first workpiece comprising a first type of titanium, wherein the first type of titanium is one of an alpha type titanium or a beta type titanium. A second workpiece comprising a second type of titanium is provided, wherein the second type of titanium is one of an alpha type titanium or a beta type titanium, and wherein the second type of titanium is different from the first type of titanium. A filler metal is selected, wherein the filler metal comprises an alpha-beta type titanium and the selected filler metal is melted to form a weld that joins the first and second workpieces.

According to the present teachings, a weld joining two dissimilar types of titanium is provided. The weld includes a first workpiece comprising a first weld edge, wherein the first workpiece comprises a first type of titanium and the first type of titanium is an alpha type titanium or a beta type titanium. The weld further includes a second workpiece comprising a second weld edge, wherein the second workpiece comprises a second type of titanium and the second type of titanium is an alpha type titanium or a beta type titanium, and wherein the second type of titanium is different from the first type of titanium. A weld portion is disposed between the first and second weld edges, wherein the weld portion comprises a filler metal comprising an alpha-beta type titanium.

According to the present teachings, another method for welding dissimilar types of titanium is provided. The method includes providing a first workpiece comprising a first type of titanium, wherein the first type of titanium is one of an alpha type titanium, a beta type titanium, or an alpha-beta type titanium. A second workpiece comprising a second type of titanium is provided, wherein the second type of titanium is one of an alpha type titanium, a beta type titanium, or an alpha-beta type titanium, and wherein the second type of titanium is different from the first type of titanium. A filler metal is selected, wherein the filler metal is one of an alpha type titanium, a beta type titanium, and an alpha-beta type titanium, and wherein the filler metal is different from the first type of titanium and the second type of titanium. The filler metal is then melted to form a weld that joins the first and second workpieces.

According to the present teachings, another weld joining two dissimilar types of titanium is provided. The weld includes a first workpiece comprising a first weld edge, wherein the first workpiece comprises a first type of titanium and the first type of titanium is an alpha type titanium, a beta type titanium or an alpha-beta type titanium. The weld further includes a second workpiece comprising a second weld edge, wherein the second workpiece comprises a second type of titanium and the second type of titanium is an alpha type titanium, a beta type titanium or an alpha-beta type titanium, and wherein the second type of titanium is different from the first type of titanium. A weld portion is disposed between the first and second weld edges, wherein the weld portion comprises a filler metal comprising an alpha type titanium, a beta type titanium or an alpha-beta type titanium, and wherein the filler metal is different from the first type and the second type of titanium.

It is to be understood that both the foregoing general description and the following detailed description are exemplary and explanatory only and are not restrictive of the disclosure, as claimed.

### BRIEF DESCRIPTION OF THE DRAWINGS

The accompanying drawings, which are incorporated in and constitute a part of this specification, illustrate the present disclosure and together with the description, serve to explain the principles of the present disclosure.

FIG. 1 schematically depicts a hexagonal close packed unit cell of certain titanium and titanium alloys;

FIG. 2 schematically depicts a body center cubic unit cell of certain titanium alloys;

FIGS. 3A-C depict a method of welding dissimilar types of titanium alloys according to the present teachings;

FIG. 4 depicts a weld joining dissimilar types of titanium alloys according to the present teachings;

FIG. 5 is a graph plotting ultimate tensile strength for conventional welds and welds according to the present teachings;

FIG. 6 is a graph showing fatigue strength at room temperature for conventional welds and welds according to the present teachings;

FIG. 7 is a graph showing fatigue strength of conventional welds and welds according to the present teachings after exposure to 700 degrees Fahrenheit for 1000 hours;

FIG. 8 is a graph showing high temperature fatigue strength of conventional welds and welds according to the present teachings after exposure to 1200 degrees Fahrenheit for 10 hours.

### DESCRIPTION

Reference will now be made in detail to exemplary implementations of the present disclosure, examples of which are illustrated in the accompanying drawings. Wherever possible, the same reference numbers will be used throughout the drawings to refer to the same or like parts. In the following description, reference is made to the accompanying drawings that form a part thereof, and in which is shown by way of illustration specific exemplary implementations in which the present disclosure can be practiced. These implementations are described in sufficient detail to enable those skilled in the art to practice the present disclosure and it is to be understood that other implementations can be utilized and that changes can be made without departing from the scope of the present disclosure. The following description is, therefore, merely exemplary.

Welding dissimilar types of titanium requires use of a filler metal to fill a gap between the workpieces being joined. Dissimilar types of titanium can be, for example, welding an alpha type titanium to a beta type titanium, welding an alpha type titanium to an alpha-beta type titanium, or welding a beta type titanium to an alpha-beta type titanium. As discussed above, the filler metal has conventionally been selected to match one of the types of titanium being welded. For example, when welding an alpha type titanium workpiece to a beta type titanium workpiece, the filler metal must be either an alpha type or a beta type titanium to match one of the workpieces. This insures proper strength at the weld joint. In exemplary implementations, use of a titanium filler metal of a different type of titanium than the dissimilar types of titanium being welded is disclosed. The weld formed by the inventive method has comparable tensile strength to conventional welds formed using a matching filler metal. Surprisingly, however, the inventive weld joint using a filler metal of a different type of titanium than the workpieces to be joined demonstrated enhanced fatigue life. This can extend the service lifetime for welded titanium components and reduce part weight and replacement costs. The enhanced fatigue life was also evident at elevated temperatures providing additional opportunities for using welding to join dissimilar types of titanium that may be subject to high temperature environments.

As used herein, the terms “type” and “phase” are used interchangeably to refer to the three classifications of titanium and its alloys, alpha, beta, and alpha-beta.

As used herein, unless otherwise noted, the term “titanium” refers to pure titanium and titanium alloys.

As used herein the term “alpha” type or phase titanium refers to titanium alloys having an aluminum equivalent (Al_{eq}) from about 5.8 to about 8.0 weight percent and a molybdenum equivalent (Mo_{eq}) from about 1.3 to about 2.0 weight percent. The aluminum equivalent for a titanium alloy is determined by:

Al_{eq}=Al+(Zr/6)+(Sn/3)+(O×10) Eq. 1

where Al is the weight percent of aluminum, Zr is the weight percent of zirconium, Sn is the weight percent of tin, and O is the weight percent of oxygen in the titanium alloy. Unless otherwise specified, weight percent refers to the weight of the alloying element relative to the total weight of the titanium alloy. The molybdenum equivalent for a titanium alloy is determined by:

Mo_{eq}=Mo+(Ta/5)+(Nb/3.6)+(W/2.5)+(V/1.5)+(Cr×1.25)+(Ni×1.25)+(Mn×1.7)+(Co×1.7)+(Fe×2.5) Eq. 2

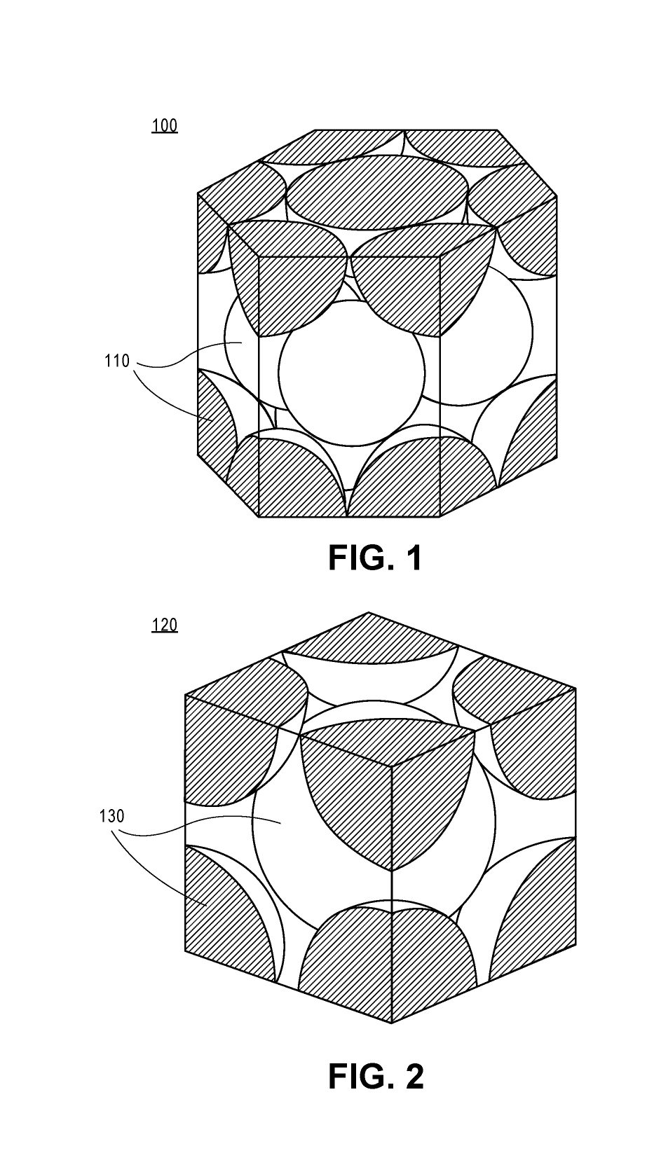

In Equation 2, Mo is the weight percent of molybdenum, Ta is the weight percent of tantalum, Nb is the weight percent of niobium, W is the weight percent of tungsten, V is the weight percent of vanadium, Cr is the weight percent of chromium, Ni is the weight percent of nickel, Mn is the weight percent of manganese, Co is the weight percent of cobalt, and Fe is the weight percent of iron in the titanium alloy. Alpha type titanium generally has a hexagonal closed packed crystal structure as shown in FIG. 1. An alpha type titanium alloy comprises 90% or more alpha type titanium, which can be determined, for example, by quantitative metallographic techniques such as microscopic image analysis and scanning electron microscope (SEM) backscatter electron (BSE) techniques.

As used herein, the term “beta” type or beta phase titanium alloys refers to titanium alloys having a Al_{eq} less than about 3.0 weight percent and a Mo_{eq} greater than about 10.0 weight percent. Al_{eq} and Mo_{eq} can be determined by Eq. 1 and Eq.2, respectively. Beta type titanium generally has a body centered cubic crystal structure as shown in FIG. 2. A beta type titanium alloy comprises a volume fraction of about 50% or more beta type titanium, which can be determined, for example, by quantitative metallographic techniques such as microscopic image analysis and scanning electron microscope (SEM) backscatter electron (BSE) techniques.

As used herein, the term “alpha-beta” type titanium refers to titanium alloys that have an Al_{eq} from about 3.0 to about 7.0 weight percent and a Mo_{eq} from about 2.1 to about 10.0 weight percent. Al_{eq} and Mo_{eq} can be determined by Eq. 1 and Eq. 2, respectively. Microstructurally, alpha-beta type titanium includes a mixture of both alpha type and beta type. The amount of beta type titanium comprises a volume fraction from about 10% to about 50%. The amounts of each type can be determined, for example, by quantitative metallographic techniques such as microscopic image analysis and scanning electron microscope (SEM) backscatter electron (BSE) techniques.

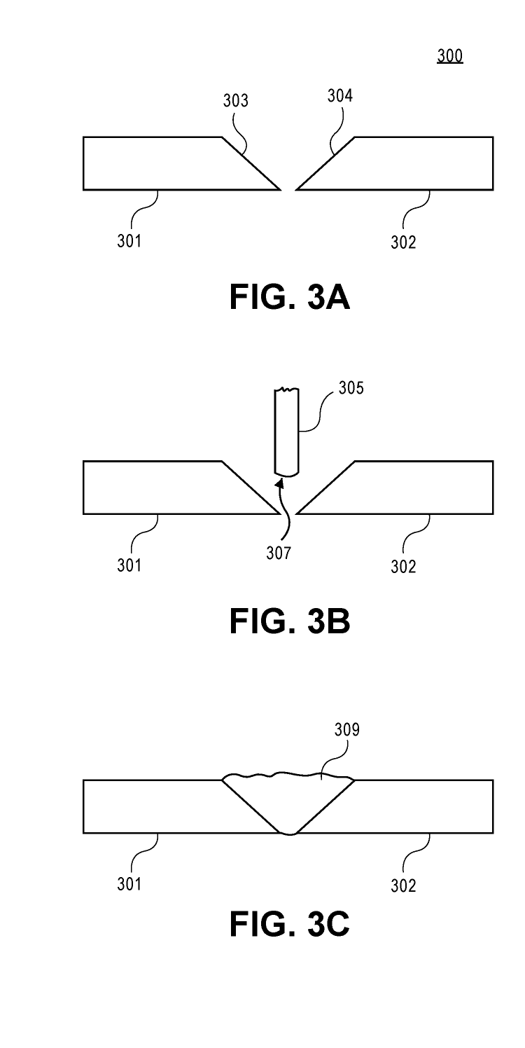

FIGS. 3A-C illustrate an exemplary method 300 for welding two dissimilar types of titanium according to the present disclosure. At FIG. 3A, a first workpiece 301 is provided that is formed of a first type of titanium, either alpha, beta, or alpha-beta. First workpiece 301 has a first weld edge 303. First weld edge 303 is the surface or point where first workpiece 301 will be joined to another workpiece. A second workpiece 302 is provided that is formed of a second type of titanium that is different than the first workpiece. For example, first workpiece 301 can be formed of alpha type titanium and second workpiece 302 can be formed of beta type titanium. Second workpiece 302 can include a second weld edge 304. Second weld edge 304 is the surface or point where second workpiece 302 will be joined to first workpiece 301. At FIG. 3B, a filler metal 305 is selected. Filler metal 305 can be an alpha, beta, or alpha-beta type titanium, but is a different type than the first type and the second type. For example, first workpiece 301 can be formed of alpha type titanium. Examples of alpha type titanium include, but are not limited to Ti—5Al—2Sn—3Li, Ti—8Al—1Mo—1V, Ti—2.5Cu, Ti-6242, Ti—6Al—2Nb—1Ta—0.8 Mo, Ti—5Al—2.5Sn, Ti—5Al—5Sn—2Zr—2Mo, Ti—3Al—2.5V, Ti—5Al—2.5Sn Extra Low Interstitial, Ti—6Al—2Sn—4Zr—2Mo—0.1Si, Ti—6Al—2.75Sn—4Zr—0.4Mo—0.45Si, and Ti—5.8Al—4Sn—3.5Zr—0.7Nb—0.5Mo—0.35Si. Second workpiece 302 can be formed of beta type titanium. Examples of beta type titanium include, but are not limited to Ti—13V—11Cr—3Al, Ti—8Mo—8V—2Fe—3Al, Ti-10V—2Fe—3Al, and Ti—3Al—8V—6Cr—4Mo—4Zr, Ti—11.5Mo—6Zr—4.5Sn, Ti—15V—3Al—3Cr—3Sn, Ti—15Mo—3Al—2.7Nb—0.25Si, Ti—15Mo—5Zr—3Al, Ti—5V—5Mo—5Al—3Cr, Ti—1.5Al—5.5Fe—6.8Mo, and Ti—8Mo—8V—2Fe—3Al. In this case, filler metal 305 is selected to be an alpha-beta type titanium. Examples of alpha-beta type titanium include, but are not limited to Ti—6AL—4V, Ti—6Al—2Sn—4Zr—2Mo, Ti—6Al—6V—2Sn, Ti—6Al—2Sn—4Zr—6Mo, Ti—6Al—4V Extra Low Interstitial, Ti—5Al—2Sn—2Zr—4Mo—4Cr, Ti—7Al—4Mo, Ti—4.5Al—3V—2Mo—2Fe, Ti—6Al—1.7Fe—0.1Si, Ti—6Al—2Sn—2Zr—2Mo—2Cr—0.25Si, Ti—4.5Al—5Mo—1.5Cr, Ti—5Al—4V—0.075Mo—0.5Fe, Ti—5Al—5V—1Fe, and Ti—3.5Al—2.0V—1.2Fe. As a result, selected filler metal 305 is an alpha-beta type titanium alloy formed of a different type of titanium than first workpiece 301 formed of alpha type titanium and second workpiece 302 formed of beta type titanium. One of ordinary skill in the art will understand that filler metal can also be alpha or beta type titanium when one of the workpieces is formed of alpha-beta type titanium.

At FIG. 3C, filler metal 305 (shown in FIG. 3B) is melted to form joint area 309. Depending on the type of welding technique and the associated equipment, filler metal 305 melts and flows to joint area 309 between first weld edge 303 and second weld edge 304 by capillary action. Suitable welding techniques include, but are not limited to linear friction welding, friction stir welding, gas tungsten arc welding, plasma arc welding, laser beam welding, gas tungsten arc welding (GTAW), gas metal arc welding (GMAW), plasma arc welding (PAW), electron beam welding (EBW), and submerged arc welding (SAW).

Referring again to FIG. 3C, joint area 309 joins first workpiece 301 and second workpiece 302. Although two workpieces are depicted, one of ordinary skill in the art will understand that more than two workpieces can be joined by the disclosed method. One or ordinary skill in the art will further understand that although a butt joint is depicted, other joints can be formed including, but not limited to, lap, corner, edge and tee joints. The present teachings provide a method for welding dissimilar types of titanium by selecting a filler metal that is also a dissimilar type to the workpieces being welded. Advantages of the method disclosed herein include production of titanium welds with comparable tensile strength and enhanced fatigue life at room and high temperatures compared to titanium welds produced by conventional welding.

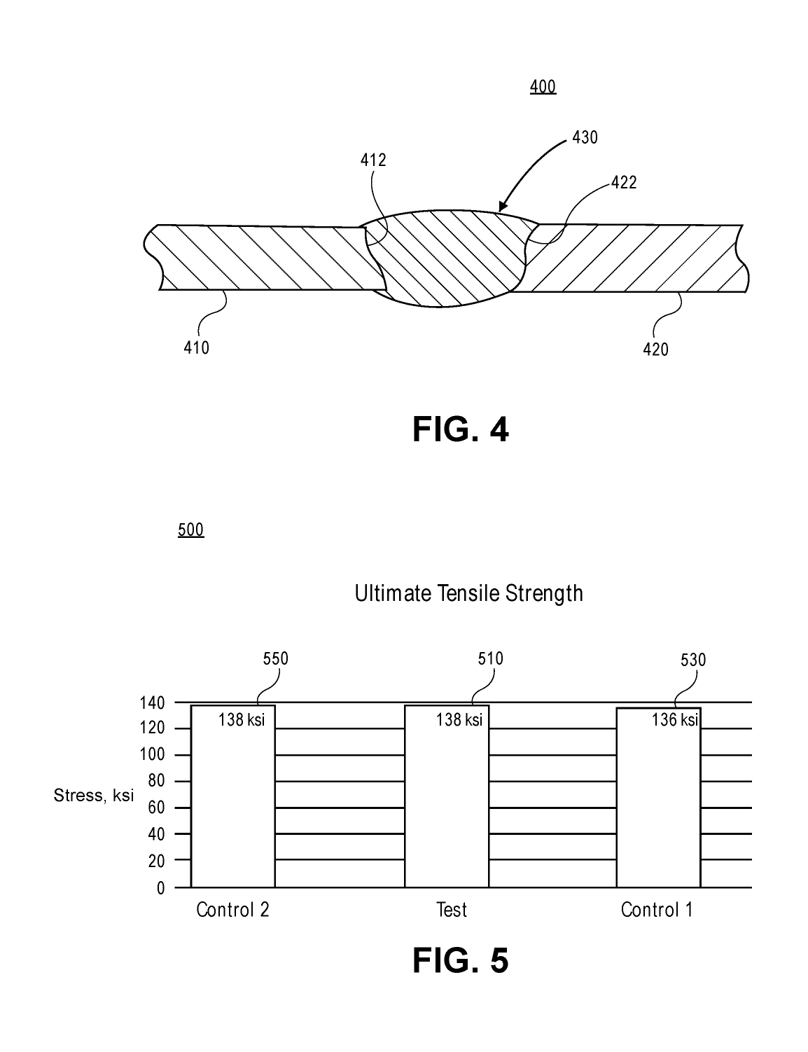

FIG. 4 schematically depicts an exemplary weld area 400 joining dissimilar types of titanium formed according to the present teachings. A weld portion 430 joins a first workpiece 410 and a second workpiece 420. First workpiece 410 comprises a first type of titanium, either an alpha type titanium, a beta type titanium, or an alpha-beta type titanium. Second workpiece 420 comprises a second type of titanium either an alpha type titanium, a beta type titanium, or an alpha-beta type titanium, but different than the first type of titanium of first workpiece 410. For example, the first type of titanium forming first workpiece 410 can be alpha type titanium and second type of titanium forming second workpiece 420 can be beta type titanium or an alpha-beta type titanium.

First workpiece 410 further includes a first weld edge 412 and second workpiece 420 includes a second weld edge 422. The weld portion 430 is disposed between first weld edge 412 and second weld edge 422 to join first workpiece 410 and second workpiece 420. Weld portion 430 is formed from the selected filler metal that is a different type of titanium than the dissimilar first and second workpieces. For example, if the first type of titanium forming first workpiece 410 is an alpha type titanium and second type of titanium forming second workpiece 420 is a beta type titanium, weld portion 430 is formed of an alpha-beta type titanium resulting from use of an alpha-beta type filler metal. One of ordinary skill in the art will understand that when second workpiece is formed of an alpha-beta type titanium, a beta type filler metal is selected so the weld portion is formed of a beta type titanium alloy. Although a butt joint is depicted in FIG. 4, one or ordinary skill in the art will understand that other joints can be formed including, but not limited to, lap, corner, edge and tee. One of ordinary skill in the art will also understand that weld area 400 can include more than two workpieces.

In another exemplary weld formed by the method schematically depicted in FIGS. 3A-C, the filler metal can be selected to include no molybdenum (Mo). For example, first workpiece 301 can be an alpha type titanium alloy, such as Ti 6242, and second workpiece 302 can be a beta type titanium alloy, such as Beta 21S. Filler metal 305 can be an alpha-beta type titanium alloy, such as Ti—6Al—4V. Referring now to FIG. 4, when the filler metal has little or no molybdenum, weld portion 430 can have a low molybdenum content and avoid negative metallurgical reactions. An additional example includes first workpiece 301 being an alpha titanium alloy with a Mo content of about 6% or less by weight and second workpiece 302 being a beta type titanium alloy with a Mo content of about 10% to about 20% by weight. By selecting an alpha-beta filler without Mo as an alloying element, the weld joint can have a low molybdenum content and avoid negative metallurgical reactions.

To demonstrate the enhanced fatigue life of the welds formed according to the present teachings, Test and Control welds were produced. To produce the Test and Control welds, first and second workpieces each having dimensions of 0.027 inch thick, 9 inches wide, and 12 inches long were welded together. Using manual gas tungsten arc welding, the workpieces were joined by a square groove weld joint formed using DC straight polarity and an argon back purge. The welded workpieces formed a panel of about 12×18 inches. The panels were then heated at 1200 degrees Fahrenheit for 8 hours before coupons for testing were cut. The Test welds were coupons cut from panels welded using the alpha beta filler metal and the Control welds were coupons cut from panels welded using alpha or beta filler metal.

The Test welds used an alpha-beta type titanium filler metal, Ti—6Al—4V, to join first workpieces formed of a beta type titanium alloy, Ti—15Mo—3Nb—3Al—0.2Si, to second workpieces formed of an alpha type titanium alloy, TI—6Al—2Sn—4Zr—2Mo—Si. Therefore, the Test welds joined alpha type titanium to a beta type titanium using an alpha-beta type titanium filler metal.

Control welds 1 were formed by joining the beta type Ti—15Mo—3Nb—3Al—0.2Si workpieces with alpha type TI—6Al—2Sn—4Zr—2Mo—Si workpieces using beta type Ti—15Mo—3Nb—3Al—0.2Si as the filler metal. Control welds 2 were formed by joining the beta type Ti—15Mo—3Nb—3Al—0.2Si workpieces with alpha type TI—6Al—2Sn—4Zr—2Mo—Si workpieces using alpha type TI—6Al—2Sn—4Zr—2Mo—Si as the filler metal. Therefore, Control 1 welds joined alpha type titanium to beta type titanium using a beta type titanium filler metal while Control welds 2 joined beta type titanium to alpha type titanium using an alpha type titanium filler metal.

The ultimate tensile strength for the Test and Control welds was determined in accordance with ASTM E-8 using the tensile specimen configuration shown in FIG. 10 of ASTM E-8 using three specimens per condition. The welds were located in the center of the gauge section of the test specimens. Graph 500 depicted in FIG. 5 shows the average ultimate tensile strength for the Test welds (510), Control 1 welds (530), and Control welds 2 (550). The Test welds, joining the dissimilar alpha type titanium (Ti—6Al—2Sn—4Zr—2Mo—Si) workpieces to the beta type titanium (Ti—15Mo—3Nb—3Al—0.2Si) workpieces using an alpha-beta filler metal (Ti—6Al—4V), had an average ultimate tensile strength of about 138 ksi. Control welds 2, joining the dissimilar alpha type titanium (Ti—6Al—2Sn—4Zr—2Mo—Si) workpieces to the beta type titanium (Ti—15Mo—3Nb—3Al—0.2Si) workpieces, but using an alpha type titanium filler metal (Ti—6Al—2Sn—4Zr—2Mo—Si) similar to the alpha type titanium workpiece, had an average ultimate tensile strength of 138 ksi. Control welds 1, joining the dissimilar alpha type titanium (Ti—6Al—2Sn—4Zr—2Mo—Si) workpieces to the beta type titanium (Ti—15Mo—3Nb—3Al—0.2Si) workpieces, but using a beta type titanium filler metal (Ti—15Mo—3Nb—3Al—0.2Si) similar to the beta type titanium workpiece, had an average ultimate tensile strength of about 136 ksi. These results demonstrated no loss of tensile strength for welds joining dissimilar types of titanium by a filler metal that is also dissimilar to the types of titanium being joined when compared to conventional welds of dissimilar types of titanium joined by a filler metal similar to one of the types of titanium being welded.

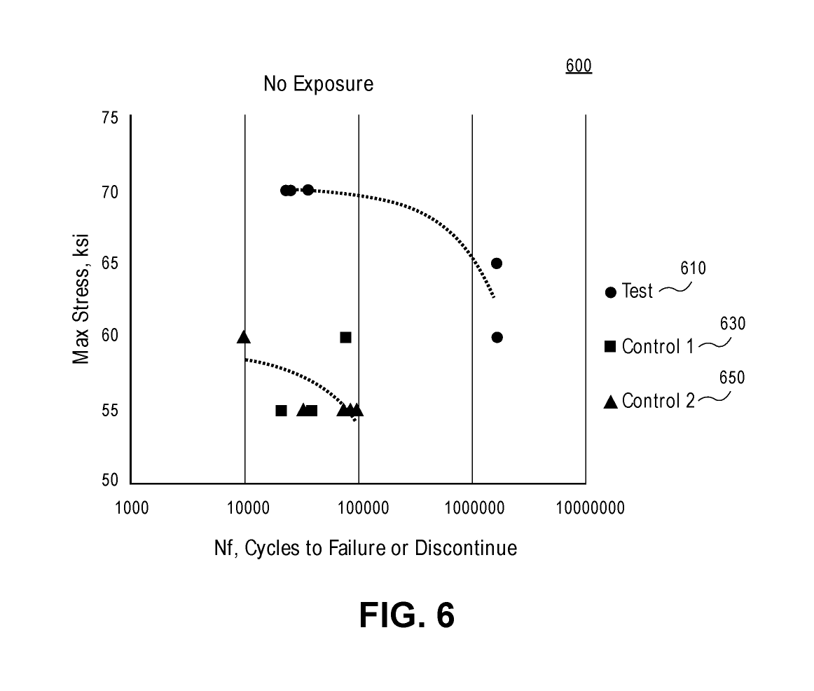

Fatigue life at room temperature for the Test and Control welds was determined in accordance with ASTM E-466 using an r ratio of +0.06 and a frequency of 10 cycles per second. A specimen with a Kt (stress intensity factor) equal to 1.0 was used. The weld was located in the center of the specimen gage section. FIG. 6 shows a graph 600 of fatigue life at room temperature for the Test and Control welds. Graph 600 plots the average number of cycles to failure versus maximum stress in ksi. The average number of cycles to failure for Control welds 1 (630) and Control welds 2 (650) was between 10,000 and 100,000 cycles at maximum stresses of about 55 and about 60 ksi. In contrast, the Test welds (610) demonstrated a greater number of cycles to failure at higher maximum stresses. For example, the average number of cycles to failure for the Test welds was more than 1,000,000 cycles at increased maximum stresses of about 60 ksi and about 65 ksi. Increasing the maximum stress to about 70 ksi, resulted in an average number of cycles to failure of between 10,000 and 100,000 cycles. These results demonstrate a significant improvement in fatigue life at room temperature for welds of dissimilar types of titanium alloys joined by a filler metal that is also dissimilar to the welded titanium alloys compared to conventional welds using a filler metal similar to one of the welded titanium alloys.

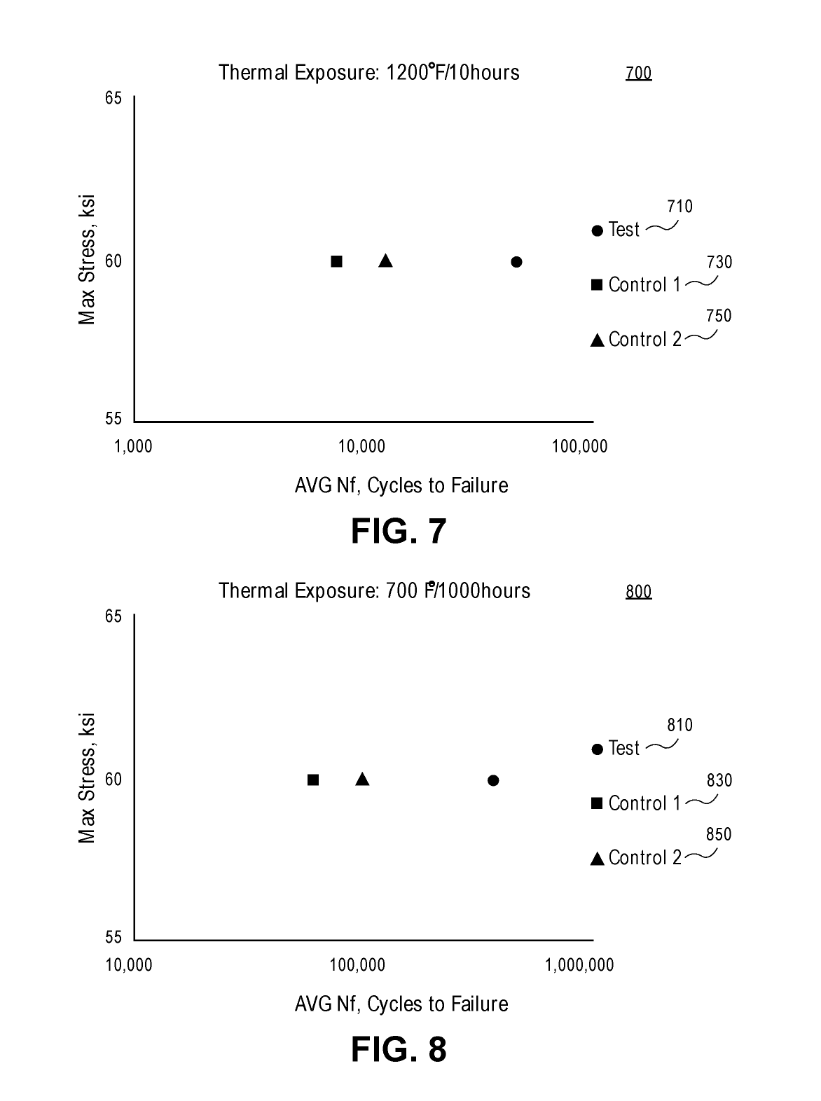

High temperature fatigue life for the Test and Control welds were tested in accordance with ASTM E-466 with the same test parameters and the specimen configuration as the room temperature fatigue specimens. FIG. 7 shows a graph 700 of high temperature fatigue life after thermal exposure to 1200 degrees Fahrenheit for 10 hours. Graph 700 plots the average number of cycles to failure versus maximum stress in ksi. At a maximum stress of about 60 ksi, the average number of cycles to failure of Control Welds 1 (730) was about 8,000. At the same maximum stress of about 60 ksi, the average number of cycles to failure of Control Welds 2 (750) was about 13,000. In contrast, at the same 60 ksi maximum stress, Test welds (710) had an average of over 49,000 cycles to failure. These results show a dramatic improvement in fatigue life at high temperatures for dissimilar types of titanium joined using a filler metal that is also dissimilar to the types of titanium being welded compared to conventional welds using a filler metal similar to one of the welded titanium alloys.

FIG. 8 shows a graph 800 of high temperature fatigue life after thermal exposure to 700 degrees Fahrenheit for 1000 hours. Graph 800 plots the average number of cycles to failure versus maximum stress in ksi. At a maximum stress of about 60 ksi, the average number of cycles to failure of Control Welds 1 (830) was about 67,000. At the same maximum stress of about 60 ksi, the average number of cycles to failure of Control Welds 2 (850) was about 100,000. The Test welds (810) at the same 60 ksi maximum stress, however, had an average of over 410,000 cycles before failure. As before, these results show a dramatic improvement in fatigue life at high temperatures for dissimilar types of titanium joined using a filler metal that is also dissimilar to the types of titanium being welded compared to conventional welds using a filler metal similar to one of the welded titanium alloys.

While the present teachings have been illustrated with respect to one or more implementations, alterations and/or modifications can be made to the illustrated examples without departing from the spirit and scope of the appended claims. For example, it will be appreciated that while the process is described as a series of acts or events, the present teachings are not limited by the ordering of such acts or events. Some acts can occur in different orders and/or concurrently with other acts or events apart from those described herein. For example, steps of the methods have been described as first, second, third, etc. As used herein, these terms refer only to relative order with respect to each other, e.g., first occurs before second. Also, not all process stages may be required to implement a methodology in accordance with one or more aspects or implementations of the present teachings. It will be appreciated that structural components and/or processing stages can be added or existing structural components and/or processing stages can be removed or modified. Further, one or more of the acts depicted herein can be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items can be selected. As used herein, the term “one or more of” with respect to a listing of items such as, for example, A and B, means A alone, B alone, or A and B. The term “at least one of” is used to mean one or more of the listed items can be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed can be somewhat altered, as long as the alteration does not result in nonconformance of the process or structure to the illustrated implementation. Finally, “exemplary” indicates the description is used as an example, rather than implying that it is an ideal. Other implementations of the present teachings will be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A method for welding dissimilar types of titanium comprising:
providing a first workpiece comprising a first type of titanium, wherein the first type of titanium is one of an alpha type titanium or a beta type titanium;
providing a second workpiece comprising a second type of titanium, wherein the second type of titanium is one of an alpha type titanium or a beta type titanium, and wherein the second type of titanium is different from the first type of titanium;
selecting a filler metal, wherein the filler metal comprises an alpha-beta type titanium; and
melting the filler metal to form a weld that joins the first and second workpieces.

2. The method of claim 1, wherein,
the alpha type titanium comprises an aluminum equivalent (Al_{eq}) from about 5.8 to about 8.0 weight percent and a molybdenum equivalent (Mo_{eq}) from about 1.3 to about 2.0 weight percent,
the beta type titanium comprises an Al_{eq} of about 3.0 weight percent or less and a Mo_{eq} of about 10.0 weight percent or more,
the alpha-beta type titanium comprises an Al_{eq} from about 3.0 to about 7.0 weight percent and a Mo_{eq} from about 2.1 to about 10.0 weight percent,
and wherein the Al_{eq} is determined by Al_{eq}=Al+(Zr/6)+(Sn/3)+(O×10), where Al is a weight percent of aluminum, Zr is a weight percent of zirconium, Sn is a weight percent of tin, and O is a weight percent of oxygen, and
the Mo_{eq} is determined by Mo_{eq}=Mo+(Ta/5)+(Nb/3.6)+(W/2.5)+(V/1.5)+(Cr×1.25)+(Ni×1.25)+(Mn×1.7)+(Co×1.7)+(Fe×2.5), where Mo is a weight percent of molybdenum, Ta is a weight percent of tantalum, Nb is a weight percent of niobium, W is a weight percent of tungsten, V is a weight percent of vanadium, Cr is a weight percent of chromium, Ni is a weight percent of nickel, Mn is a weight percent of manganese, Co is a weight percent of cobalt, and Fe is a weight percent of iron.

3. The method of claim 1, wherein the alpha type titanium comprises more than about 90% alpha type titanium.

4. The method of claim 1, wherein the alpha type titanium comprises titanium, Ti—5Al—2Sn—3Li, Ti—8Al—1Mo—1V, Ti—2.5Cu, Ti—6242, Ti—6Al—2Nb—1Ta—0.8 Mo, Ti—5Al—2.5Sn, Ti—5Al—55n—2Zr—2Mo, Ti—3Al—2.5V, Ti—5Al—2.5Sn Extra Low Interstitial, Ti—6Al—2Sn—4Zr—2Mo—0.1Si, Ti—6Al—2.75Sn—4Zr—0.4Mo—0.45Si, or Ti—5.8Al—45n—3.5Zr—0.7Nb—0.5Mo—0.35Si.

5. The method of claim 1, wherein the beta type titanium comprises at least 50% beta type titanium.

6. The method of claim 1, wherein the beta type titanium comprises Ti—13V—11Cr—3Al, Ti—8Mo—8V—2Fe—3Al, Ti—10V—2Fe—3Al, and Ti—3Al—8V—6Cr—4Mo—4Zr, Ti—11.5Mo—6Zr—4.5Sn, Ti—15V—3Al—3Cr—3Sn, Ti—15Mo—3Al—2.7Nb—0.25Si, Ti—15Mo—5Zr—3Al, Ti—5V—5Mo—5Al—3Cr, Ti—1.5Al—5.5Fe—6.8Mo, or Ti—8Mo—8V—2Fe—3Al.

7. The method of claim 1, wherein the alpha-beta type titanium that is selected comprises no molybdenum.

8. The method of claim 1, wherein the alpha-beta type titanium comprises Ti—6AL—4V, Ti—6Al—2Sn—4Zr—2Mo, Ti—6Al—6V—2Sn, Ti—6Al—2Sn—4Zr—6Mo, Ti—6Al—4V Extra Low Interstitial, Ti—5Al—2Sn—2Zr—4Mo—4Cr, Ti—7Al—4Mo, Ti—4.5Al—3V—2Mo—2Fe, Ti—6Al—1.7Fe—0.1Si, Ti—6Al—2Sn—2Zr—2Mo—2Cr—0.25Si, Ti—4.5Al—5Mo—1.5Cr, Ti—5Al—4V—0.075Mo—0.5Fe, Ti—5Al—5V—1Fe, or Ti—3.5Al—2.0V—1.2Fe.

9. The method of claim 1 wherein melting the filler metal comprises using one or more of linear friction welding, friction stir welding, gas tungsten arc welding, plasma arc welding, laser beam welding, gas tungsten arc welding, gas metal arc welding, plasma arc welding, electron beam welding, or submerged arc welding.

10. A weld joining two dissimilar types of titanium comprising:
a first workpiece comprising a first weld edge, wherein the first workpiece comprises a first type of titanium and the first type of titanium is an alpha type titanium or a beta type titanium;
a second workpiece comprising a second weld edge, wherein the second workpiece comprises a second type of titanium and the second type of titanium is an alpha type titanium or a beta type titanium, and wherein the second type of titanium is different from the first type of titanium; and
a weld portion disposed between the first and second weld edges, wherein the weld portion comprises a filler metal comprising an alpha-beta type titanium.

11. The weld of claim 10, wherein,
the alpha type titanium comprises an aluminum equivalent (Al_{eq}) from about 5.8 to about 8.0 weight percent and a molybdenum equivalent (Mo_{eq}) from about 1.3 to about 2.0 weight percent,
the beta type titanium comprises an Al_{eq} of about 3.0 weight percent or less and a Mo_{eq} of about 10.0 weight percent or more,
the alpha-beta type titanium comprises an Al_{eq} from about 3.0 to about 7.0 weight percent and a Mo_{eq} from about 2.1 to about 10.0 weight percent,
and wherein the Al_{eq} is determined by Al_{eq}=Al+(Zr/6)+(Sn/3)+(O×10), where Al is a weight percent of aluminum, Zr is a weight percent of zirconium, Sn is a weight percent of tin, and O is a weight percent of oxygen, and
the Mo_{eq} is determined by Mo_{eq}=Mo+(Ta/5)+(Nb/3.6)+(W/2.5)+(V/1.5)+(Cr x 1.25)+(Ni×1.25)+(Mn×1.7)+(Co×1.7)+(Fe×2.5), where Mo is a weight percent of molybdenum, Ta is a weight percent of tantalum, Nb is a weight percent of niobium, W is a weight percent of tungsten, V is a weight percent of vanadium, Cr is a weight percent of chromium, Ni is a weight percent of nickel, Mn is a weight percent of manganese, Co is a weight percent of cobalt, and Fe is a weight percent of iron.

12. The weld of claim 10, wherein the alpha type titanium comprises more than about 90% alpha type titanium.

13. The weld of claim 10, wherein the alpha type titanium comprises titanium, Ti—5Al—2Sn—3Li, Ti—8Al—1Mo—1V, Ti—2.5Cu, Ti—6242, Ti—6Al—2Nb—1Ta—0.8 Mo, Ti—5Al—2.5Sn, Ti—5Al—55n—2Zr—2Mo, Ti—3Al—2.5V, Ti—5Al—2.5Sn Extra Low Interstitial, Ti—6Al—2Sn—4Zr—2Mo—0.1Si, Ti—6Al—2.75Sn—4Zr—0.4Mo—0.45Si, or Ti—5.8Al—45n—3.5Zr—0.7Nb—0.5Mo—0.35Si.

14. The weld of claim 10, wherein the beta type titanium comprises at least 50% beta type titanium.

15. The weld of claim 10, wherein the beta type titanium comprises Ti—13V—11Cr—3Al, Ti—8Mo—8V—2Fe—3Al, Ti—10V—2Fe—3Al, and Ti—3Al—8V—6Cr—4Mo—4Zr, Ti—11.5Mo—6Zr—4.5Sn, Ti—15V—3Al—3Cr—3Sn, Ti—15Mo—3Al—2.7Nb—0.25Si, Ti—15Mo—5Zr—3Al, Ti—5V—5Mo—5Al—3Cr, Ti—1.5Al—5.5Fe—6.8Mo, or Ti—8Mo—8V—2Fe—3Al.

16. The weld of claim 10, wherein the alpha-beta type titanium comprises Ti—6AL—4V, Ti—6Al—2Sn—4Zr—2Mo, Ti—6Al—6V—2Sn, Ti—6Al—2Sn—4Zr—6Mo, Ti—6Al—4V Extra Low Interstitial, Ti—5Al—2Sn—2Zr—4Mo—4Cr, Ti—7Al—4Mo, Ti—4.5Al—3V—2Mo—2Fe, Ti—6Al—1.7Fe—0.1Si, Ti—6Al—2Sn—2Zr—2Mo—2Cr—0.25Si, Ti—4.5Al—5Mo—1.5Cr, Ti—5Al—4V—0.075Mo—0.5Fe, Ti—5Al—5V—1Fe, or Ti—3.5Al—2.0V—1.2Fe.

17. The weld of claim 10, wherein the first type of titanium comprises a molybdenum content of about 6% or less by weight, the second type of titanium comprises a molybdenum content of about 10% to about 20% by weight, and the filler metal comprising the alpha-beta type titanium comprises no molybdenum.

18. A weld joining two dissimilar types of titanium comprising:
a first workpiece comprising a Ti—6Al—2Sn—4Zr—2Mo titanium alloy;
a second workpiece comprising a beta type titanium; and
a weld portion joining the first and second workpieces, wherein the weld portion comprises a filler metal comprising Ti—6Al—4V.
